(19) United States
(12) Patent Application Publication
(10) Pub. No.: US 2018/0013132 A1
(43) Pub. Date: Jan. 11, 2018

(54) METHOD FOR MANUFACTURING NONAQUEOUS ELECTROLYTE SECONDARY BATTERY

(71) Applicant: Sanyo Electric Co., Ltd., Daito-shi, Osaka (JP)

(72) Inventors: Sanae Chiba, Osaka (JP); Akira Nagasaki, Osaka (JP); Atsushi Ueda, Osaka (JP)

(73) Assignee: Sanyo Electric Co., Ltd., Daito-shi, Osaka (JP)

(21) Appl. No.: 15/546,374

(22) PCT Filed: Feb. 22, 2016
(86) PCT No.: PCT/JP2016/000920

§ 371 Date: Jul. 26, 2017

(30) Foreign Application Priority Data
Feb. 27, 2015 (JP) 2015-038617

(51) Int. Cl. H01M 4/1391; H01M 10/058; H01M 4/48; H01M 4/62; H01M 4/04; H01M 4/525; H01M 4/587; H01M 10/0525

(52) U.S. Cl. CPC H01M 4/1391; H01M 4/587; H01M 10/058; H01M 10/0525; H01M 4/623; H01M 4/0404; H01M 4/525; H01M 4/483; H01M 4/0471; H01M 2220/30

(57) ABSTRACT

A method for manufacturing a nonaqueous electrolyte secondary battery according to an embodiment of the present invention is a method for manufacturing a nonaqueous electrolyte secondary battery including a positive electrode plate and a negative electrode plate provided with a negative electrode mixture layer containing graphite and a silicon material and includes a step of applying positive electrode mixture slurry containing a lithium-transition metal composite oxide and polyvinylidene fluoride to a positive electrode current collector, a step of forming a positive electrode mixture layer by drying the positive electrode mixture slurry, and a step of heat-treating the positive electrode mixture layer. The temperature of heat treatment is preferably 160° C. to 350° C.

### TECHNICAL FIELD

The present invention relates to a method for manufacturing a nonaqueous electrolyte secondary battery including a negative electrode plate containing graphite and a silicon material as negative electrode active materials and a positive electrode plate containing polyvinylidene fluoride as a binder.

### BACKGROUND ART

In recent years, nonaqueous electrolyte secondary batteries have been widely used as power supplies for driving portable electronic devices such as smartphones, tablet computers, notebook personal computers, and portable music players. As the portable electronic devices are becoming increasingly compact and highly functional, the nonaqueous electrolyte secondary batteries are required to have further high capacity.

A carbon material such as graphite is used as a negative electrode active material for the nonaqueous electrolyte secondary batteries. The carbon material has a discharge potential comparable to that of metallic lithium and can suppress the dendritic growth of lithium during charge. Therefore, using the carbon material as a negative electrode active material enables nonaqueous electrolyte secondary batteries excellent in safety to be provided. Graphite can store lithium ions to form the composition LiC₆ and exhibits a theoretical capacity of 372 mAh/g.

However, carbon materials currently used already exhibit a capacity close to the theoretical capacity thereof; hence, it is difficult to increase the capacity of nonaqueous electrolyte secondary batteries by improving negative electrode active materials. Therefore, in recent years, silicon materials, such as silicon and oxides thereof, having a capacity higher than that of the carbon materials have been attracting attention as negative electrode active materials for nonaqueous electrolyte secondary batteries. For example, silicon can store lithium ions to foLm the composition Li₄.₄Si and exhibits a theoretical capacity of 4,200 mAh/g. Therefore, using the silicon materials as negative electrode active materials allows nonaqueous electrolyte secondary batteries to have increased capacity.

The silicon materials, as well as the carbon materials, can suppress the dendritic growth of lithium during charge. However, the silicon materials show a large expansion and contraction due to charge and discharge as compared to the carbon materials, and therefore have a problem of inferior cycle characteristics because of the pulverization of negative electrode active materials, the peel-off from conductive networks, or the like.

Patent Literature 1 discloses a nonaqueous electrolyte secondary battery including a negative electrode mixture layer containing a material containing Si and O as constituent elements and graphite as a negative electrode active material and a positive electrode mixture layer containing a lithium transition metal oxide represented by the formula Li_{1+y}MO₂ (where −0.3≦y≦0.3, M represents two or more elements including at least Ni, and the percentage of Ni in the elements making up M is 30% by mole to 95% by mole) as a positive electrode active material, wherein the initial charge/discharge efficiency of a positive electrode is lower than that of a negative electrode.

Patent Literature 2 discloses a method for manufacturing a nonaqueous electrolyte secondary battery, the method comprising compressing a positive electrode plate and then heat-treating the positive electrode plate in a temperature range from Tm−30 to Tm+20, where Tm (° C.) is the melting point of polyvinylidene fluoride contained in a positive electrode mixture layer. This technique is intended to suppress the decomposition reaction of a nonaqueous electrolyte on a positive electrode active material by covering an active site of the positive electrode active material with polyvinylidene fluoride when the positive electrode active material is cracked during compression and therefore the active site is exposed.

Patent Literature 3 discloses a nonaqueous electrolyte secondary battery including a positive electrode plate, a negative electrode plate, and a porous insulating layer placed therebetween, the tensile elongation of the positive electrode plate being 3.0% or more. Patent Literature 3 describes that after a positive electrode mixture layer is compressed, the positive electrode plate is heat-treated for the purpose of increasing the tensile elongation of the positive electrode plate. The nonaqueous electrolyte secondary battery is provided for the purpose of preventing short circuiting and uses aluminium foil containing iron as a positive electrode current collector for the purpose of preventing the reduction of capacity due to heat treatment.

### CITATION LIST

### Patent Literature

PTL 1: Japanese Published Unexamined Patent Application No. 2012-169300

PTL 2: Japanese Published Unexamined Patent Application No. 2007-273259

PTL 3: Japanese Published Unexamined Patent Application No. 2009-64770

### SUMMARY OF INVENTION

### Technical Problem

In a nonaqueous electrolyte secondary battery containing a negative electrode active material, such as silicon oxide, having low initial charge/discharge efficiency, the potential of a positive electrode varies more significantly than that of a negative electrode during discharge. Therefore, in an initial stage of a charge/discharge cycle, the deterioration of silicon oxide is promoted, thereby reducing cycle characteristics. As described in Patent Literature 1, the variation in potential of a negative electrode can be reduced using a positive electrode having an initial charge/discharge efficiency lower than that of the negative electrode. However, the battery capacity of a nonaqueous electrolyte secondary battery is regulated by a positive electrode and therefore when the initial charge/discharge efficiency of the positive electrode is too low, the battery capacity is low. In this case, an advantage in using such a negative electrode active material, such as silicon oxide, having high capacity cannot be sufficiently exhibited. This is a problem common to silicon oxide and silicon materials including silicon.

If the decomposition reaction of a nonaqueous electrolyte on a positive electrode active material can be suppressed as described in Patent Literature 2, the enhancement of cycle characteristics is expected. However, cycle characteristics obtained using a negative electrode active material, such as silicon oxide, having low initial charge/discharge efficiency are not at all investigated in Patent Literature 2.

The heat treatment of the positive electrode plate described in Patent Literature 3 is intended to increase the tensile elongation. Cycle characteristics obtained using a negative electrode active material, such as silicon oxide, having low initial charge/discharge efficiency are not at all investigated therein.

The present invention has been made in view of the above circumstances and is intended to enhance cycle characteristics of a nonaqueous electrolyte secondary battery containing graphite and a silicon material as negative electrode active materials.

### Solution to Problem

A method for manufacturing a nonaqueous electrolyte secondary battery, according to an embodiment of the present invention, for solving the above problem is a method for manufacturing a nonaqueous electrolyte secondary battery including a positive electrode plate and a negative electrode plate provided with a negative electrode mixture layer containing graphite and a silicon material and includes a step of applying positive electrode mixture slurry containing a lithium-transition metal composite oxide and polyvinylidene fluoride to a positive electrode current collector, a step of forming a positive electrode mixture layer by drying the positive electrode mixture slurry, and a step of heat-treating the positive electrode mixture layer.

### Advantageous Effect of Invention

According to an embodiment of the present invention, a nonaqueous electrolyte secondary battery having high capacity and excellent cycle characteristics can be provided.

### BRIEF DESCRIPTION OF DRAWING

FIG. 1 is a cross-sectional perspective view of a nonaqueous electrolyte secondary battery used in an experiment example.

### DESCRIPTION OF EMBODIMENTS

Embodiments of the present invention are described with reference to various experiment examples including the embodiments of the present invention. The present invention is not limited to the experiment examples below. Modifications can be made without departing from the scope of the present invention.

### EXPERIMENT EXAMPLE 1

(Preparation of positive electrode plate)

As a positive electrode active material, a lithium-transition metal composite oxide having the composition LiNi_{0.82}Co_{0.15}Al_{0.03}O₂ was used. The following materials were mixed together: 100 parts by mass of the positive electrode active material, 1.25 parts by mass of acetylene black serving as a conductive agent, and 1.7 parts by mass of polyvinylidene fluoride serving as a binder. The mixture was put into N-methylpyrrolidone (NMP) serving as a dispersion medium, followed by kneading, whereby positive electrode mixture slurry was prepared. The positive electrode mixture slurry was applied to both surfaces of a positive electrode current collector, made of aluminium, having a thickness of 15 μm by a doctor blade process, followed by drying in a 100° C. to 150° C. environment, whereby positive electrode mixture layers were famed. After the positive electrode mixture layers were compressed using a compression roll so as to have a thickness of 0.177 mm, the positive electrode mixture layers were heat-treated in such a manner that a roll heated to 250° C. was brought into contact with the surface of each positive electrode mixture layer for 0.7 seconds. Finally, a heat-treated positive electrode plate was cut, whereby a positive electrode plate 11, according to Experiment Example 1, having a length of 656 mm and a width of 58.5 mm was prepared.

(Preparation of negative electrode plate)

As a silicon material silicon oxide having the composition SiO (corresponding to the formula SiOₓ, where x=1) was used. SiO was heated to 1,000° C. in an inert gas atmosphere and particles of SiO were surface-coated with carbon by a chemical vapor deposition (CVD) process in such a manner that a hydrocarbon gas was pyrolyzed. The coating amount of carbon was 1% by mass with respect to SiO. A negative electrode active material was prepared in such a manner that 1 part by mass of SiO and 99 parts by mass of graphite were mixed together.

Into water serving as a dispersion medium, 100 parts by mass of the negative electrode active material and 1 part by mass of styrene-butadiene rubber (SBR) serving as a binder were put, followed by kneading, whereby negative electrode mixture slurry was prepared. The negative electrode mixture slurry was applied to both surfaces of a negative electrode current collector, made of copper, having a thickness of 8 μm by a doctor blade process, followed by drying, whereby negative electrode mixture layers were formed. The negative electrode mixture layers were compressed using a compression roll so as to have a predetermined thickness, followed by cutting, whereby a negative electrode plate 13, according to Experiment Example 1, having a length of 590 mm and a width of 59.5 mm was prepared.

(Preparation of nonaqueous electrolyte)

Ethylene carbonate (EC) and dimethyl carbonate (DMC) were mixed at a volume ratio of 1:3, whereby a nonaqueous solvent was prepared. To the nonaqueous solvent, 5% by mass of vinylene carbonate was added, followed by dissolving lithium hexafluorophosphate (LiPF₆) at a concentration of 1 mol/L, whereby a nonaqueous electrolyte was prepared.

(Preparation of electrode assembly)

A positive electrode lead 12 and a negative electrode lead 14 were connected to the positive electrode plate 11 and the negative electrode plate 13, respectively. The positive electrode plate 11 and the negative electrode plate 13 were wound with a polyethylene separator 15 therebetween, whereby an electrode assembly 16 was prepared.

(Preparation of nonaqueous electrolyte secondary battery)

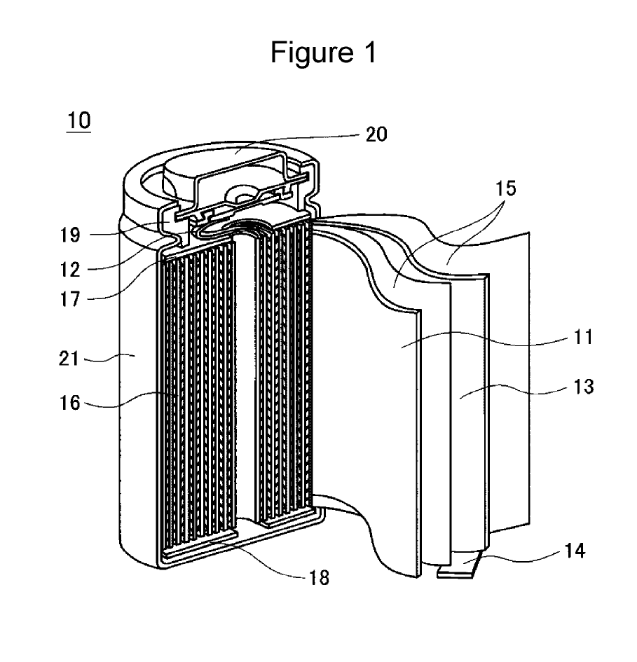

As shown in FIG. 1, an upper insulating plate 17 and a lower insulating plate 18 were provided on the top and bottom, respectively, of the electrode assembly 16 and the electrode assembly 16 was housed in an outer can 21. The negative electrode lead 14 was connected to a bottom portion of the outer can 21. The positive electrode lead 12 was connected to a terminal board of a sealing body 20. Next, the nonaqueous electrolyte was poured into the outer can 21 under reduced pressure. The sealing body 20 was fixed to an opening of the outer can 21 by swaging with a gasket 19 therebetween, whereby a nonaqueous electrolyte secondary battery 10 having a design capacity of 3,400 mAh was prepared.

### EXPERIMENT EXAMPLE 2

A nonaqueous electrolyte secondary battery 10 according to Experiment Example 2 was prepared in substantially the same manner as that used in Experiment Example 1 except that positive electrode mixture layers were not heat-treated.

### EXPERIMENT EXAMPLE 3

A nonaqueous electrolyte secondary battery 10 according to Experiment Example 3 was prepared in substantially the same manner as that used in Experiment Example 1 except that the content of SiO was 4% by mass with respect to the sum of the masses of graphite and SiO.

### EXPERIMENT EXAMPLE 4

A nonaqueous electrolyte secondary battery 10 according to Experiment Example 4 was prepared in substantially the same manner as that used in Experiment Example 3 except that positive electrode mixture layers were not heat-treated.

### EXPERIMENT EXAMPLE 5

A nonaqueous electrolyte secondary battery 10 according to Experiment Example 5 was prepared in substantially the same manner as that used in Experiment Example 1 except that the content of SiO was 7% by mass with respect to the sum of the masses of graphite and SiO.

### EXPERIMENT EXAMPLE 6

A nonaqueous electrolyte secondary battery 10 according to Experiment Example 6 was prepared in substantially the same manner as that used in Experiment Example 5 except that positive electrode mixture layers were not heat-treated.

### EXPERIMENT EXAMPLE 7

A nonaqueous electrolyte secondary battery 10 according to Experiment Example 7 was prepared in substantially the same manner as that used in Experiment Example 3 except for using a lithium-transition metal composite oxide having the composition LiNi_{0.85}Co_{0.12}Al_{0.03}O₂ as a positive electrode active material.

### EXPERIMENT EXAMPLE 8

A nonaqueous electrolyte secondary battery 10 according to Experiment Example 8 was prepared in substantially the same manner as that used in Experiment Example 3 except for using a lithium-transition metal composite oxide having the composition LiNi_{0.88}Co_{0.09}Al_{0.03}O₂ as a positive electrode active material.

### EXPERIMENT EXAMPLE 9

A nonaqueous electrolyte secondary battery 10 according to Experiment Example 9 was prepared in substantially the same manner as that used in Experiment Example 5 except for using a lithium-transition metal composite oxide having the composition LiNi_{0.88}Co_{0.09}Al_{0.03}O₂ as a positive electrode active material.

### EXPERIMENT EXAMPLE 10

A nonaqueous electrolyte secondary battery 10 according to Experiment Example 10 was prepared in substantially the same manner as that used in Experiment Example 1 except for using polycrystalline silicon (Si) with an average particle diameter (median diameter D50) of 5 μm instead of SiO coated with carbon.

### EXPERIMENT EXAMPLE 11

A nonaqueous electrolyte secondary battery 10 according to Experiment Example 11 was prepared in substantially the same manner as that used in Experiment Example 10 except that positive electrode mixture layers were not heat-treated.

### EXPERIMENT EXAMPLE 12

(Preparation of silicon-graphite composite)

In a nitrogen gas atmosphere, monocrystalline Si particles were put into methylnaphthalene serving as a solvent together with a bead mill and were wet-milled so as to have an average particle diameter (median diameter D50) of 0.2 μm, whereby silicon-containing slurry was prepared. Graphite particles and carbon pitch were added to the silicon-containing slurry, followed by mixing and carbonizing the carbon pitch. The product was classified so as to have a particle diameter in a predetermined range, followed by adding carbon pitch. The carbon pitch was carbonized, whereby a silicon-graphite composite in which the Si particles and the graphite particles were bound with amorphous carbon was prepared. The content of silicon in this composite was 20.9% by mass.

A nonaqueous electrolyte secondary battery 10 according to Experiment Example 12 was prepared in substantially the same manner as that used in Experiment Example 5 except for using the silicon-graphite composite prepared as described above instead of SiO coated with carbon.

### EXPERIMENT EXAMPLE 13

A nonaqueous electrolyte secondary battery 10 according to Experiment Example 13 was prepared in substantially the same manner as that used in Experiment Example 10 except that positive electrode mixture layers were not heat-treated.

### EXPERIMENT EXAMPLE 14

(Preparation of silicon-lithium silicate composite)

In an inert gas atmosphere, Si particles and lithium silicate (Li₂SiO₃) particles were mixed at a mass ratio of 42:58 and the mixture was milled in a planetary ball mill. The particles milled in the inert gas atmosphere were taken out and were then heat-treated at 600° C. for 4 hours in an inert gas atmosphere. The heat-treated particles (hereinafter referred to as the core particles) were milled and were mixed with coal pitch, followed by heat treatment at 800° C. for 5 hours in an inert gas atmosphere, whereby a conductive layer of carbon was famed on the surface of each core particle. The content of carbon contained in the conductive layer was 5% by mass with respect to the sum of the masses of the core particle and the conductive layer. Finally, the core particles were classified, whereby a silicon-lithium silicate composite with an average particle diameter of 5 μm was prepared.

(Analysis of silicon-lithium silicate composite)

A cross section of the silicon-lithium silicate composite was observed with a scanning electron microscope (SEM). As a result, the average diameter of the Si particles contained in the composite was less than 100 nm. Furthermore, it was confirmed that the Si particles were uniformly dispersed in a Li₂SiO₃ phase. In an XRD pattern of the silicon-lithium silicate composite, a diffraction peak assigned to each of Si and Li₂SiO₃ was observed. The full width at half maximum of the plane indices (111) of Li₂SiO₃ that was found at 2θ=27° in the XRD pattern was 0.233. In the XRD pattern, no peak assigned to SiO₂ was observed. The content of SiO₂ measured by Si-NMR was below the lower limit of detection.

A nonaqueous electrolyte secondary battery 10 according to Experiment Example 14 was prepared in substantially the same manner as that used in Experiment Example 5 except for using the silicon-lithium silicate composite prepared as described above instead of SiO coated with carbon.

### EXPERIMENT EXAMPLE 15

A nonaqueous electrolyte secondary battery 10 according to Experiment Example 15 was prepared in substantially the same manner as that used in Experiment Example 14 except that the positive electrode mixture layers were not heat-treated.

### EXPERIMENT EXAMPLE 16

A nonaqueous electrolyte secondary battery 10 according to Experiment Example 16 was prepared in substantially the same manner as that used in Experiment Example 2 except that no SiO was used as a negative electrode active material.

### EXPERIMENT EXAMPLE 17

A nonaqueous electrolyte secondary battery 10 according to Experiment Example 17 was prepared in substantially the same manner as that used in Experiment Example 16 except that positive electrode mixture layers were heat-treated.

(Measurement of initial charge/discharge efficiency of positive electrode)

A two-electrode cell was prepared using a piece, cut out of the positive electrode plate prepared in each experiment example, having a predetermined size as a working electrode and pieces of metallic lithium foil as a counter electrode and a reference electrode. The initial charge capacity and initial discharge capacity of the positive electrode plate were measured under conditions below using the two-electrode cell, whereby the initial charge/discharge efficiency of the positive electrode was determined. The working electrode using the positive electrode plate was charged at a constant current density of 7 mA/cm² until the potential of the working electrode reached 4.3 V versus the reference electrode. Thereafter, while the potential of the working electrode was maintained at 4.3 V versus the reference electrode, the working electrode was charged until the current density reached 1.4 mA/cm². The charge capacity determined in this manner was defined as the initial charge capacity Qc1. After an interval of 10 minutes, the working electrode using the positive electrode plate was discharged at a constant current density of 7 mA/cm² until the potential of the working electrode reached 2.5 V versus the reference electrode. The discharge capacity determined in this manner was defined as the initial discharge capacity Qd1. The percentage of Qd1 to Qc1 was calculated, whereby the initial charge/discharge efficiency of the positive electrode was obtained.

(Measurement of initial charge/discharge efficiency of negative electrode)

A two-electrode cell was prepared using a piece, cut out of the negative electrode plate prepared in each experiment example, having a predetermined size as a working electrode and pieces of metallic lithium foil as a counter electrode and a reference electrode. The initial charge capacity and initial discharge capacity of the negative electrode plate were measured under conditions below using the two-electrode cell, whereby the initial charge/discharge efficiency of the negative electrode was determined. The working electrode using the negative electrode plate was charged at a constant current density of 7 mA/cm² until the potential of the working electrode reached 0.01 V versus the reference electrode. Thereafter, while the potential of the working electrode was maintained at 0.01 V versus the reference electrode, the working electrode was charged until the current density reached 1 mA/cm². The charge capacity determined in this manner was defined as the initial charge capacity Qc2. After an interval of 10 minutes, the working electrode using the negative electrode plate was discharged at a constant current density of 7 mA/cm² until the potential of the working electrode reached 1.0 V versus the reference electrode. The discharge capacity determined in this manner was defined as the initial discharge capacity Qd2. The percentage of Qd2 to Qc2 was calculated, whereby the initial charge/discharge efficiency of the negative electrode was obtained.

[Evaluation of Cycle Characteristics]

The battery of each of Experiment Examples 1 to 17 was charged with a constant current of 0.3 lt (=1,020 mA) in a 25° C. environment until the voltage of the battery reached 4.2 V. Thereafter, the battery was charged with a constant voltage of 4.2 V until the current reached 0.01 lt (=34 mA). Next, the battery was discharged with a constant current of 1 lt (=3,400 mA) until the battery voltage reached 2.5 V. The charge-discharge was defined as one cycle and 500 cycles were repeated. The first-cycle discharge capacity and the 500th-cycle discharge capacity were measured. The capacity retention after 500 cycles was calculated from the following equation:

Capacity retention (%)=(500th-cycle discharge capacity/first-cycle discharge capacity)×100

Results of the initial charge/discharge efficiency of the positive and negative electrodes and cycle characteristics are shown in Tables 1 to 4. In the tables, the Ni content is expressed in terms of a mole percentage to each lithium-transition metal composite oxide that is a positive electrode active material.

TABLE 1

| | Positive electrode | | | Negative electrode | | Difference in initial | |
|---|---|---|---|---|---|---|---|
| | | | Initial | | Initial | charge/discharge | |
| | | Ni content | charge/discharge | | charge/discharge | efficiency between | Capacity |
| | Heat | (mole | efficiency | SiO content | efficiency | positive and negative | retention |
| | treatment | percent) | (percent) | (mass percent) | (percent) | electrodes | (percent) |
| Experiment | Performed | 82 | 94.5 | 1 | 93.8 | 0.7 | 84 |
| Example 1 | | | | | | | |
| Experiment | Not | | 96.7 | | | 2.9 | 81 |
| Example 2 | performed | | | | | | |
| Experiment | Performed | | 94.5 | 4 | 89.5 | 5.0 | 77 |
| Example 3 | | | | | | | |
| Experiment | Not | | 96.7 | | | 7.2 | 75 |
| Example 4 | performed | | | | | | |
| Experiment | Performed | | 94.5 | 7 | 87.2 | 7.3 | 75 |
| Example 5 | | | | | | | |
| Experiment | Not | | 96.7 | | | 9.5 | 73 |
| Example 6 | performed | | | | | | |

Table 1 is one that summarizes results of Experiment Examples 1 to 6 for the purpose of simply showing the effect of heat-treating the positive electrode mixture layers. As is clear from Table 1, although the increase in SiO content of each negative electrode active material reduces the capacity retention, the capacity retention is uniformly increased by the heat treatment of the positive electrode mixture layers regardless of the SiO content. One of reasons for the increase of the capacity retention is probably that the heat treatment of the positive electrode mixture layers reduces the difference in initial charge/discharge efficiency between the positive and negative electrodes.

TABLE 2

| | Positive electrode | | | Negative electrode | | Difference in initial | |
|---|---|---|---|---|---|---|---|
| | | | Initial | | Initial | charge/discharge | |
| | | | charge/discharge | SiO content | charge/discharge | efficiency between | Capacity |
| | Heat | Ni content | efficiency | (mass | efficiency | positive and | retention |
| | treatment | (mole percent) | (percent) | percent) | (percent) | negative electrodes | (percent) |
| Experiment | Performed | 82 | 94.5 | 4 | 89.5 | 5.0 | 77 |
| Example 3 | | | | | | | |
| Experiment | | 85 | 93.5 | | | 4.0 | 79 |
| Example 7 | | | | | | | |
| Experiment | | 88 | 92.3 | | | 2.8 | 81 |
| Example 8 | | | | | | | |
| Experiment | | 82 | 94.5 | 7 | 87.2 | 7.3 | 75 |
| Example 5 | | | | | | | |
| Experiment | | 88 | 92.3 | | | 5.1 | 77 |
| Example 9 | | | | | | | |

Table 2 is one that summarizes results of Experiment Examples 3, 5, and 7 to 9 for the purpose of confirming the influence of the Ni content of each positive electrode active material. Comparing Experiment Examples 3, 7, and 8 shows that the increase in Ni content of the positive electrode active material increases the capacity retention. Comparing Experiment Examples 5 and 9 shows that a similar result is obtained. From these results, it is conceivable that the Ni content of the positive electrode active material is preferably 85% by mole or more and more preferably 88% by mole or more.

Incidentally, in consideration of the results shown in Table 1, an effect of the present invention depends significantly on the heat treatment of the positive electrode mixture layers and SiO in the negative electrode active materials. Therefore, even in the case of using a positive electrode active material other than the lithium-nickel composite oxides used in the experiment examples, a similar effect is expected to be obtained.

TABLE 3

| | Positive electrode | | | Negative electrode | | Difference in initial | |
|---|---|---|---|---|---|---|---|
| | | | Initial | | Initial | charge/discharge | |
| | | | charge/discharge | | charge/discharge | efficiency between | Capacity |
| | Heat | Ni content | efficiency | Silicon | efficiency | positive and negative | retention |
| | treatment | (mole percent) | (percent) | material | (percent) | electrodes | (percent) |
| Experiment | Performed | 82 | 94.5 | Si | 87.3 | 7.2 | 76 |
| Example 10 | | | | | | | |
| Experiment | Not | | 96.7 | | | 9.4 | 73 |
| Example 11 | performed | | | | | | |
| Experiment | Performed | | 94.5 | Si-graphite | 87.2 | 7.3 | 77 |
| Example 12 | | | | composite | | | |
| Experiment | Not | | 96.7 | | | 9.5 | 74 |
| Example 13 | performed | | | | | | |
| Experiment | Performed | | 94.5 | Si—Li₂SiO₃ | 87.3 | 7.2 | 76 |
| Example 14 | | | | composite | | | |
| Experiment | Not | | 96.7 | | | 9.4 | 73 |
| Example 15 | performed | | | | | | |

Table 3 is one that summarizes results of Experiment Examples 10 to 15 for the purpose of confirming the influence of using silicon materials other than SiO. As is clear from Table 3, an effect similar to that obtained using SiO is obtained using any of silicon, the Si-graphite composite, and the Si-Li₂SiO₃ composite as a silicon material. Therefore, it is conceivable that the present invention can be widely applied to silicon-containing compounds and silicon-containing composites capable of storing and releasing lithium.

TABLE 4

| | Positive electrode | | | Negative electrode | | Difference in initial | |
|---|---|---|---|---|---|---|---|
| | | | Initial | | Initial | charge/discharge | |
| | | Ni content | charge/discharge | | charge/discharge | efficiency between | Capacity |
| | Heat | (mole | efficiency | SiO content | efficiency | positive and negative | retention |
| | treatment | percent) | (percent) | (mass percent) | (percent) | electrodes | (percent) |
| Experiment | Not | 82 | 96.7 | 0 | 95.4 | 1.3 | 83 |
| Example 16 | performed | | | | | | |
| Experiment | Performed | | 94.5 | | | 0.9 | 83 |
| Example 17 | | | | | | | |

Table 4 is one that summarizes results of Experiment Examples 16 and 17 for the purpose of showing the effect of heat-treating the positive electrode mixture layers in the case of using a negative electrode active material containing no SiO. As is clear from Table 4, there is no difference in capacity retention between Experiment Examples 16 and 17. Therefore, in order to exhibit an effect of the present invention, a negative electrode active material needs to contain a silicon material.

The embodiments of the present invention are further described with reference to the above results of the experiment examples.

A positive electrode active material is not limited to the lithium-nickel composite oxides shown in the experiment examples and may be a lithium-transition metal composite oxide capable of storing and releasing lithium ions. Examples of the lithium-transition metal composite oxide include the formulas LiMO₂ (M is at least one of Co, Ni, and Mn), LiMn₂O₄, and LiFePO₄. These lithium-transition metal composite oxides may be used alone or in combination. Furthermore, these lithium-transition metal composite oxides can be used in such a manner that at least one selected from the group consisting of Al, Ti, Mg, and Zr is added to these lithium-transition metal composite oxides or a transition metal element therein is partially substituted with at least one selected from the group consisting of Al, Ti, Mg, and Zr.

Among the exemplified lithium-transition metal composite oxides, a nickel-cobalt composite oxide is preferable. The content of Ni in the lithium-nickel composite oxide is preferably 85% by mole or more and more preferably 88% by mole or more. The foLmula LiₐNi_{b}Co_{c}M(_{1-b-c)}O₂ (where 0<a≦1.2, 0.8≦b≦1, 0≦c≦0.2, and M is at least one selected from the group consisting of Al, Mn, Mg, Ti, and Zr) is exemplified as a preferable composition formula for the nickel-cobalt composite oxide. The formula LiₐNi_{b}Co_{c}M_{(1-b-c)}O₂ (where 0<a≦1.2, 0.85≦b≦1, 0≦c≦0.15, and M is at least one selected from the group consisting of Al, Mn, Mg, Ti, and Zr) is exemplified as a more preferable composition formula for the nickel-cobalt composite oxide. In the formulas, a, which represents the content of Li, is set within the above range in consideration of the fact that a varies during charge and discharge. In nonaqueous electrolyte secondary batteries immediately after being prepared, a preferably satisfies 0.95≦a≦1.2.

A silicon material that is a compound containing Si and O as constituent elements can be used without limitations. A silicon material represented by the formula SiOₓ (0.5≦x<1.6) is preferably used.

Although it is not necessarily essential to coat the surface of silicon oxide with carbon as described in the experiment examples, the surface of silicon oxide is preferably coated with carbon because the conductivity of silicon oxide can be increased. It is sufficient that the surface of silicon oxide is partly coated with carbon. The coating amount of carbon is preferably 0.1% by mass to 10% by mass with respect to silicon oxide and more preferably 0.1% by mass to 5% by mass.

The silicon material used may be silicon alone or a composite of silicon and another material. Silicon used may be any of monocrystalline silicon, polycrystalline silicon, and amorphous silicon. Polycrystalline silicon with a grain size of 60 nm or less and amorphous silicon are preferable. Using such silicon reduces the cracking of particles during charge and discharge to enhance cycle characteristics. The average particle diameter (median diameter D50) of silicon is preferably 0.1 μm to 10 μm and more preferably 0.1 μm to 5 μm. Techniques for obtaining silicon having such an average particle diameter include dry milling processes using a jet mill or a ball mill and wet milling processes using a bead mill or a ball mill. Silicon may be alloyed with at least one metal element selected from the group consisting of nickel, copper, cobalt, chromium, iron, silver, titanium, molybdenum, and tungsten.

As a material that forms a composite together with silicon, a material having the effect of absorbing the significant change in volume of silicon due to charge or discharge is preferably used. Examples of such a material include graphite and lithium silicate.

In a silicon-graphite composite, silicon particles and graphite particles are preferably bound to each other with amorphous carbon as shown in Experiment Example 12. The graphite particles used may be particles of any of synthetic graphite and natural graphite. As a precursor of amorphous carbon used to bind the silicon particles and the graphite particles together, a pitch material, a tar material, and a resin material can be used. Examples of the resin material include vinyl resins, cellulose resins, and phenol resins. These amorphous carbon precursors can be converted into amorphous carbon by heat treatment at 700° C. to 1,300° C. in an inert gas atmosphere. In the case where the silicon particles and the graphite particles are bound together with amorphous carbon, amorphous carbon is included in components of the silicon-graphite composite. The content of silicon in the silicon-graphite composite is preferably 10% by mass to 60% by mass.

A silicon-lithium silicate composite preferably has a structure in which silicon particles are dispersed in a lithium silicate phase as shown in Experiment Example 14. The surface of the silicon-lithium silicate composite, as well as SiOₓ, may be coated with carbon. In this case, carbon is an arbitrary component and is not any component of the silicon-lithium silicate composite. The content of silicon in the silicon-lithium silicate composite is preferably 40% by mass to 60% by mass.

Incidentally, SiOₓ microscopically has a structure in which Si particles are dispersed in a SiO₂ phase. It is conceivable that the SiO₂ acts to absorb the expansion and contraction of Si during charge and discharge. However, in the case of using SiOₓ in a negative electrode active material, SiO₂ reacts with lithium (Li) as shown by Equation (1).

2SiO₂+8Li⁻+8e→Li₄Si+Li₄SiO₄ (1)

Li₄SiO₄, which is famed by the reaction of SiO₂ with Li, cannot reversibly intercalate or deintercalate lithium. Therefore, the irreversible capacity due to the formation of Li₄SiO₄ during the first charge is accumulated in a negative electrode containing SiO, as a negative electrode active material. However, unlike SiOₓ, lithium silicate does not cause any chemical reaction accumulating irreversible capacity and therefore can absorb the change in volume of Si during charge and discharge without reducing the initial charge/discharge efficiency of the negative electrode.

Lithium silicate used is not limited to Li₂SiO₃ shown in Experiment Example 14 and may be lithium silicate represented by the formula Li_{2z}SiO_{(2+z)}(0<z<2). In an XRD pattern, the full width at half maximum of the diffraction peak corresponding to the (111) plane of lithium silicate is preferably 0.05° or more. This further enhances the lithium ion conductivity in particles of the silicon-lithium silicate composite and the effect of absorbing the change in volume of Si.

Cycle characteristics of a nonaqueous electrolyte secondary battery containing the silicon material can be enhanced by the heat treatment of a positive electrode mixture layer and therefore the content of the silicon material in a negative electrode active material is not particularly limited. However, in consideration of the balance between the capacity and cycle characteristics of the battery, the content of the silicon material is preferably 4% by mass to 20% by mass with respect to the sum of the masses of graphite and silicon oxide and more preferably 4% by mass to 10% by mass.

A nonaqueous electrolyte used may be one obtained by dissolving a lithium salt serving as an electrolyte salt in a nonaqueous solvent. A nonaqueous electrolyte containing a gelled polymer instead of or together with the nonaqueous solvent can be used.

The nonaqueous solvent used may be any of cyclic carbonates, linear carbonates, cyclic carboxylates, and linear carboxylates, which are preferably used in combination. Examples of the cyclic carbonates include ethylene carbonate (EC), propylene carbonate (PC), and butylene carbonate (BC). A cyclic carbonate, such as fluoroethylene carbonate (FEC), in which hydrogen is partially substituted with fluorine can be used. Examples of the linear carbonates include dimethyl carbonate (DMC), ethyl methyl carbonate (EMC), diethyl carbonate (DEC), and methyl propyl carbonate (MPC). Examples of the cyclic carboxylates include γ-butyrolactone (γ-BL) and γ-valerolactone (γ-VL). Examples of the linear carboxylates include methyl pivalate, ethyl pivalate, methyl isobutyrate, and methyl propionate.

Examples of the lithium salt include LiPF₆, LiBF₄, LiCF₃SO₃, LiN (CF₃SO₂)₂, LiN(C₂F₅SO₂)₂, LiN(CF₃SO₂) (C₄F₉SO₂), LiC (CF₃SO₂)₃, LiC(C₂F₅SO₂)₃, LiAsF₆, LiClO₄, Li₂B₁₀Cl₁₀, and Li₂B₁₂Cl₁₂. Among these, LiPF₆ is particularly preferable. The concentration of LiPF₆ in the nonaqueous electrolyte is preferably 0.5 mol/L to 2.0 mol/L. LiPF₆ may be mixed with another lithium salt such as LiBF₄.

The preferable temperature range for the heat treatment of the positive electrode mixture layer is 20° C. or more higher than the melting point of polyvinylidene fluoride and is not higher than the decomposition temperature of polyvinylidene fluoride. In particular, the temperature range for the heat treatment thereof is preferably 160° C. to 350° C. and more preferably 200° C. to 300° C. A heat treatment process is not particularly limited and may be a process in which the positive electrode mixture layer is placed in an environment in the above-mentioned temperature range. A process in which the positive electrode mixture layer is contacted with hot air or a heated roll is simple and therefore is preferable. In particular, a process using the heated roll can perform heat treatment in a short time and therefore is preferable. The heat treatment time of the positive electrode mixture layer may be appropriate determined depending on the heat treatment process. In the case of the process using the heated roll, the heat treatment time is preferably, for example, 0.1 seconds to 20 seconds.

In the case of compressing the positive electrode mixture layer, the positive electrode mixture layer may be heat-treated before or after the compression thereof. After being compressed, the positive electrode mixture layer is preferably heat-treated.

### INDUSTRIAL APPLICABILITY

According to the present invention, a nonaqueous electrolyte secondary battery having high capacity and excellent cycle characteristics can be provided. Therefore, the industrial applicability of the present invention is significant.

### REFERENCE SIGNS LIST

10 Nonaqueous electrolyte secondary battery

11 Positive electrode plate

12 Positive electrode lead

13 Negative electrode plate

14 Negative electrode lead

15 Separator

16 Electrode assembly

17 Upper insulating plate

18 Lower insulating plate

19 Gasket

20 Sealing body

21 Outer can

1. A method for manufacturing a nonaqueous electrolyte secondary battery including a positive electrode plate and a negative electrode plate provided with a negative electrode mixture layer containing graphite and a silicon material, the method comprising:
a step of applying positive electrode mixture slurry containing a lithium-transition metal composite oxide and polyvinylidene fluoride to a positive electrode current collector;
a step of forming a positive electrode mixture layer by drying the positive electrode mixture slurry; and
a step of heat-treating the positive electrode mixture layer.

2. The method for manufacturing the nonaqueous electrolyte secondary battery according to claim 1, wherein the lithium-transition metal composite oxide is represented by the formula LiₐNi_{b}Co_{c}M_{(1-b-c)}O₂ (where 0<a≦1.2, 0.8≦b≦1, 0≦c≦0.2, and M is at least one selected from the group consisting of Al, Mn, Mg, Ti, and Zr).

3. The method for manufacturing the nonaqueous electrolyte secondary battery according to claim 1, wherein the lithium-transition metal composite oxide is represented by the formula LiₐNi_{b}Co_{c}M_{(1-b-c)}O₂ (where 0<a≦1.2, 0.85≦b 1, 0≦c≦0.15, and M is at least one selected from the group consisting of Al, Mn, Mg, Ti, and Zr).

4. The method for manufacturing the nonaqueous electrolyte secondary battery according to claim 1, wherein the heat treating is performed in such a manner that the positive electrode mixture layer is contacted with hot air or a heated roll.

5. The method for manufacturing the nonaqueous electrolyte secondary battery according to claim 1, wherein the heat treating is performed at 160° C. to 350° C.

6. The method for manufacturing the nonaqueous electrolyte secondary battery according to claim 1, wherein the silicon material is silicon oxide represented by the formula SiOₓ (0.5≦x<1.6).

7. The method for manufacturing the nonaqueous electrolyte secondary battery according to claim 1, wherein the silicon material is a composite in which silicon particles and graphite particles are bound to each other with amorphous carbon.

8. The method for manufacturing the nonaqueous electrolyte secondary battery according to claim 1, wherein the silicon material is a composite in which silicon particles are dispersed in a lithium silicate phase represented by the formula Li_{2z}SiO_{(2+z)}(0<z<2).

9. The method for manufacturing the nonaqueous electrolyte secondary battery according to claim 1, wherein the content of the silicon material is 4% by mass to 20% by mass with respect to the sum of the masses of the graphite and the silicon material.
